(19) United States
(12) Patent Application Publication
(10) Pub. No.: US 2008/0228534 A1
(43) Pub. Date: Sep. 18, 2008

(54) Reservation Record Based Ticketing

(75) Inventors: Raelynn A. Sink, Lakeville, MN (US); Jillian Carpenter, Ascot (GB); John Coats, Minneapolis, MN (US)

Correspondence Address: FISH & RICHARDSON P.C., P.O. BOX 1022, MINNEAPOLIS, MN, 55440-1022, US

(73) Assignee: Accenture Global Services GmbH

(21) Appl. No.: 12/043,055

(22) Filed: Mar. 5, 2008

Related U.S. Application Data
(60) Provisional application No. 60/893,062, filed on Mar. 5, 2007.

(51) Int. Cl. G06Q 30/00; G06F 17/30

(52) U.S. Cl. 705/6; 705/5

(57) ABSTRACT

The subject matter of this specification can be embodied in, among other things, a process for processing travel transactions without tickets. The process includes generating an electronic reservation record for a traveler that includes a reservation for travel along a travel segment and modifying the electronic reservation record to include a virtual ticket value that is unassociated with an electronic or physical ticket. The process also includes digitally transmitting the electronic reservation record having the virtual ticket value to a remote computing system that uses the electronic reservation record as exclusive evidence that the reservation has been confirmed for the traveler by a travel provider. For the process, the use of the electronic reservation record is exclusive of the presence or absence of any electronic or physical tickets.

### CROSS-REFERENCE TO RELATED APPLICATIONS

This application claims priority to U.S. Application Ser. No. 60/893,062, filed on Mar. 5, 2007, and entitled “Transaction-Based Ticketing,” the contents of which are hereby incorporated in their entirety by reference.

### TECHNICAL FIELD

This instant specification relates to processing travel transactions.

### BACKGROUND

Some current airline systems use electronic or paper tickets in conjunction with reservation records to complete travel transactions. For example, if a first airline system cancels a flight for a passenger and rebooks the passenger on a second airline system, the first airline system transmits the reservation record and some evidence associated with an electronic or paper ticket record that serves as proof that the second airline system will be compensated for serving the rebooked passenger.

In the case of electronic tickets (e-tickets), the first airline system can transmit a series of messages associated with an e-ticket record stored in a database. The messages can include authorizations permitting the second airline system to assume control of the e-ticket or coupons and information associated with a coupon status of the e-ticket. Some of the information associated with the e-ticket messages can be duplicative of information stored in the reservation record associated with the e-ticket. However, both the e-ticket information as well as the reservation record is transmitted from the first airline system to the second airline system to document during the travel transaction.

In the case of paper tickets, the first airline system transmits the reservation record to the second airline and a passenger may have to present the paper ticket to the second airline for carriage or re-issuance of a new ticket (either an e-ticket or a paper ticket) by the second airline. The second airline system may then have to present the old ticket as evidence that it is entitled to compensation for servicing the passenger on the rebooked flight.

### SUMMARY

In general, this document describes processing ticketless travel transactions.

In a first general aspect, a computer-implemented process for processing travel transactions without tickets is described. The process includes generating an electronic reservation record for a traveler that includes a reservation for travel along a travel segment and modifying the electronic reservation record to include a virtual ticket value that is unassociated with an electronic or physical ticket.

The process also includes digitally transmitting the electronic reservation record having the virtual ticket value to a remote computing system that uses the electronic reservation record as exclusive evidence that the reservation has been confirmed for the traveler by a travel provider. For the process, the use of the electronic reservation record is exclusive of the presence or absence of any electronic or physical tickets.

In a second general aspect, a computer-implemented process of digitally processing travel changes between travel providers is described. The process includes digitally modifying an electronic passenger name record (PNR) with travel information that has changed. The electronic PNR comprising a requested travel itinerary and a virtual ticket value associated with a first segment of travel.

The process also includes digitally transmitting the electronic PNR having the virtual ticket value from a first travel provider system to a second travel provider for use in setting the travel itinerary and for providing exclusive evidence of a commitment to compensate the second travel provider for providing the first segment of travel to a passenger associated with the electronic PNR.

In another general aspect, a system for processing ticketless travel transactions is described. The system includes a travel agency system to generate an electronic travel reservation record having a travel segment associated with a virtual ticket value but unassociated with an electronic or physical ticket. The system also includes a travel provider system to receive the electronic travel reservation record having the virtual ticket value and to provide travel for a passenger along the travel segment without receiving any electronic or physical tickets associated with the travel segment, and the system includes a clearinghouse system to receive the virtual ticket value from the travel provider as exclusive evidence that the travel provider has committed to provide the travel along the travel segment.

The systems and techniques described here may provide one or more of the following advantages. First, evidence of a right to compensated can be provided by a travel provider without the use of electronic or paper tickets. Second, travel providers, travel agencies, and clearinghouses can eliminate the use of duplicate information provided in both reservation records and electronic ticket information. Third, a virtual ticket number can be used in accounting and transaction records of legacy systems in a substantially similar manner as electronic and paper ticket numbers are used. Fourth, travel transactions between travel providers, travel agencies, and clearinghouses can be simplified by eliminating the need to manage electronic or physical tickets.

The details of one or more embodiments are set forth in the accompanying drawings and the description below. Other features and advantages will be apparent from the description and drawings, and from the claims.

### DESCRIPTION OF DRAWINGS

FIG. 1 is a block diagram of an exemplary system for processing virtual tickets.

FIG. 2 is a sequence diagram showing exemplary interactions between components of a system for processing virtual tickets.

FIG. 3 is a flow chart of an exemplary process for determining whether an itinerary is eligible for virtual ticketing.

FIG. 4 is a schematic of a general computing system.

Like reference symbols in the various drawings indicate like elements.

### DETAILED DESCRIPTION

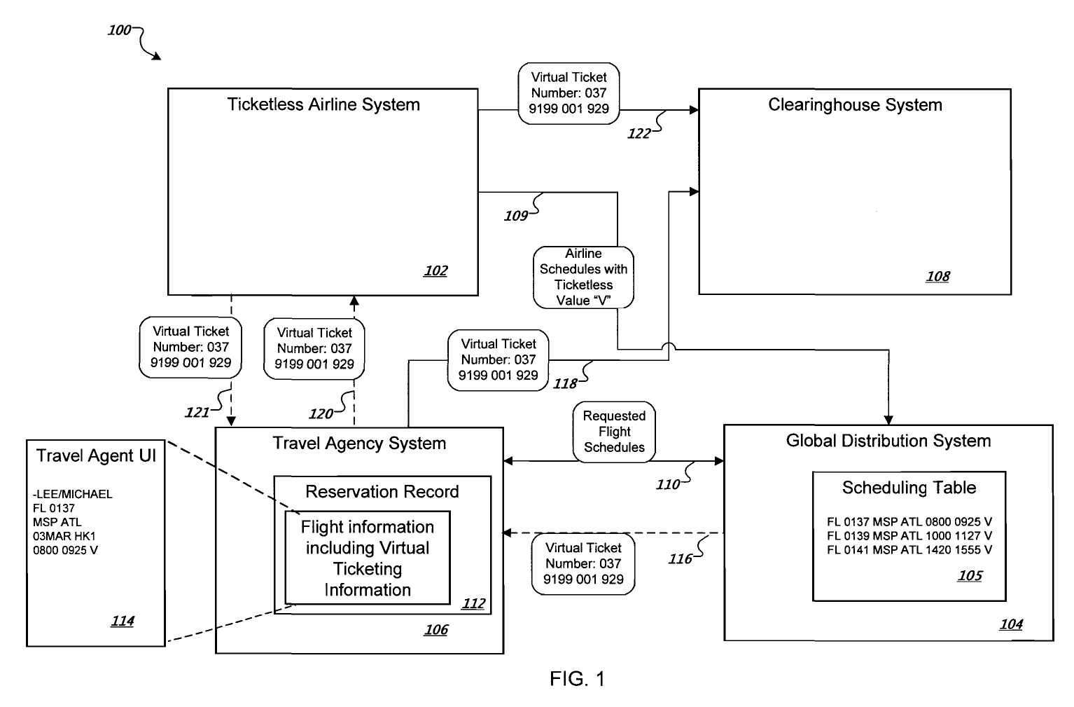

This document describes systems and techniques for processing virtual tickets, or ticketless transactions, used by entities, such as airlines. FIG. 1 is a block diagram of an exemplary system 100 for processing virtual tickets. The system 100 includes an airline system 102 that supports ticketless transactions and a global distribution system (GDS) 104 that manages, inter alia, flight schedule information for airlines. The system 100 also includes a system for purchasing tickets, or passenger seats, such as a travel agency system 106, and can include a clearinghouse system 108, which may serve as a broker between the travel agency system 106 and the airline system 102 to facilitate payment to the airline for flights purchased at the travel agency system 106.

In certain implementations, and the ticketless airline system 102, as well as other airline systems, can submit airline schedule files, such as SSIM files, to an aggregator, such as the Official Airline Guide (OAG), or directly to the GDS 104. The latter case is illustrated by arrow 109. The schedule files transmitted by the ticketless airline system 102 can include a ticketless value “V,” which indicates that an associated flight is eligible for virtual ticketing.

In certain implementations, the scheduling files can be imported or used by a scheduling table 105, which can index airline scheduling information from several airlines.

In certain implementations, the GDS 104 can determine whether each carrier allows virtual ticket segments to be combined with other segments, such as electronic ticket (e-ticket) segments, paper ticket segments, online itineraries, or inter-airline itineraries. This may be done using business logic implemented, for instance, using a rules engine. Inputs to make the determination can include information, such as the name (or other identifier) of an airline(s) for the segments, the segment type, the settlement conditions for the airline(s), etc.

When a user, such as a user at the travel agency system 106, requests flight schedules as indicated by arrow 110, a display for the travel agency system 106 can include a visual indication for flights that are virtual ticketing eligible. In certain implementations, the visual indicator can be substantially similar to current visual indicators that specify that a flight is eligible for an E-ticket.

In certain implementations, an agent (e.g., a call center agent, travel agent, or a potential passenger using a web site) can select a flight segment that is eligible for virtual ticketing and confirm the availability of a seat on the flight via a messaging transmission, such as by teletype, EDIFACT messaging, API/web services, etc. The agent can also add names and other booking data to a reservation record 112 (e.g., a passenger name record) associated with the desired flight. The format of a reservation record for a flight eligible for virtual ticketing can be implemented so that it appears substantially similar to reservation records for other ticket types (e.g., paper or e-ticket reservation records).

An example of reservation information is displayed on a travel agent UI 114 included in FIG. 1. The “V” value near the end of the example information can indicate that the flight is eligible for virtual ticketing.

In some implementations, after the flight is selected for virtual ticketing, the travel agency system 106 can optionally request a virtual ticket number from the GDS 104 as indicated by dashed arrow 116. In some implementations, the GDS 104 can generate virtual ticket numbers in sequential order. The virtual ticket number can be transmitted to the travel agency and included in a ticket field of the reservation record 112. In certain implementations, the virtual ticket number is not used to generate a ticket, such as an e-ticket or a paper ticket. However, in certain implementations, the virtual ticketing number is used in the GDS 104 and the airline system 102 accounting and transaction records in a substantially similar manner as an e-ticket number or a paper ticket number.

The virtual ticket number can then be transmitted from the travel agency system 106 to other components of the system 100, such as the clearinghouse 108 and the ticketless airline system 102, as indicated by arrow 118 and dashed arrow 120, respectively.

In other implementations, instead of requesting the virtual ticket number from the GDS 104, the travel agency system 106 can request the virtual ticket number from the ticketless airline system 107 as indicated by the dashed arrow 121. For example, the travel agency system 106 can send a message request to the airline system 107 using teletype, EDIFACT, or API/web services messaging.

The ticketless airline system 102 can generate and transmit the virtual ticket number to the travel agency system 106 for inclusion in a virtual ticket number field of the reservation record 112. The travel agency system 106 need not initiate a ticket creation process (e.g., either e-ticket or paper ticket), but the virtual ticket number can be used in accounting and transaction records for the travel agency system 106, the GDS 104, the airline system 104, and other system components in substantially the same mariner as an e-ticket or paper ticket number.

In the implementation of FIG. 1, after the airline flies the passenger, or as bi-laterally agreed, the virtual ticketing number can be transmitted to the clearinghouse system 108 for settlement, as indicated by arrow 122. For example, the clearinghouse can collect payment from the travel agency (which previously collected payment from a traveler) and transmit the payment to the airline that flew the passenger.

Additionally, the clearinghouse system 108 can use the virtual ticketing numbers to aggregate marketing data in a similar way that current systems use e-ticket or paper ticket numbers to identify and aggregate data within the clearinghouse system 108. to the travel agency system or ticketless airline system. For example, the clearinghouse system 108 can use the virtual ticket numbers to compile information associated with the virtual tickets such as origin and destination sales summaries, yearly sales comparisons, and transaction history files.

Although not depicted in FIG. 1, travel providers, such as the ticketless airline system, can transmit rescheduled travel information to another service provider (or other parties) if travel plans are modified. For example, if a passenger's flight on NORTHWEST AIRLINES is cancelled, NORTHWEST AIRLINES may cancel the reservation and rebook the passenger to fly with, for instance, AMERICAN AIRLINES.

Using the system components of FIG. 1, a travel provider can accomplish the cancellation and rebooking by modifying a travel record, or reservation record, that includes a virtual ticket value and transmitting the modified travel record to the new travel provider. For example, NORTHWEST AIRLINES can modify a reservation record for Mr. Traveler by, for example, cancelling Mr. Traveler's reservation on a Northwest Airline's flight and rebooking him on an American Airline's flight. After modifying the reservation record, Northwest Airline can transmit the modified reservation record to AMERICAN AIRLINES.

The new travel provider (i.e., the travel provider that is now responsible for servicing the traveler) can use the received reservation record—which includes the virtual ticket number—as evidence of both the new travel itinerary and as proof of a commitment to compensate the new travel provider for servicing the traveler.

In some implementations, the reservation record serves as the sole commitment to compensate for the transaction. Additional ticket, or coupon information, such E-ticket information transmitted in the UN/EDIFACT (United Nations/Electronic Data Interchange for Administration, Commerce, and Transport) standard may not be transmitted with the reservation record, and thus, may not be necessary as evidence for a commitment to compensate for the transaction. For example, the new travel provider does not have to query an e-ticket database to request control of a coupon associated with an e-ticket or physically collect a paper ticket. Instead, the virtual ticket number in the reservation record serves as proof of a commitment to compensate.

In other implementations, the reservation record (which includes the virtual ticket number) can be used alone to provide both the travel itinerary and evidence of a commitment to compensate for servicing a traveler. In yet other implementations, the reservation record having the virtual ticket number services as exclusive evidence that a reservation for travel is confirmed for a passenger by a travel provider. For example, an airline can transmit the reservation record to other components of the system 100 as exclusive proof that the airline has reserved a seat on a particular flight(s) for the date(s) specified in the reservation record.

In certain implementations, the modified reservation record (having the virtual ticket number) can be transmitted to additional parties to initiate a compensation process for the new travel provider. For example, the new travel provider (or the old travel provider) can transmit the reservation record to the travel agency system 106, which transfers compensation obtained from the traveler to the new travel provider. In other implementations, the new travel provider (or the old travel provider) transmits the travel record to a clearinghouse. The clearinghouse can then use the reservation information to identify the travel provider that should be compensated for servicing the traveler and can broker any compensation due between the travel agency system (or other third party) and the new travel provider.

In some implementations, the reservation record having the virtual ticket number is transmitted to third parties, such as the travel agency and clearinghouse system, and serves as the sole or partial evidence of a commitment to compensate.

In other implementations, the reservation record having virtual ticket information can be sent to additional travel service providers affected by the modifications. For example, a travel itinerary can include several travel segments, each serviced by a different travel provider. If one segment is cancelled or rescheduled, the reservation record reflecting the change can be transmitted to the other travel service providers included in the travel itinerary.

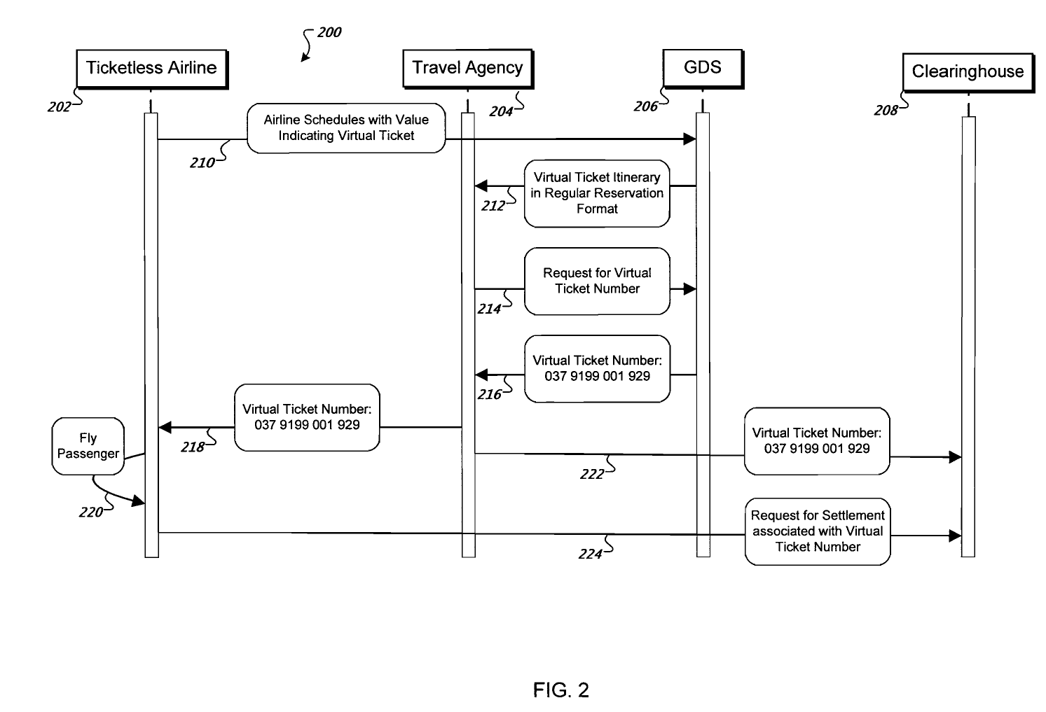

FIG. 2 is a sequence diagram 200 showing exemplary interactions between components of a system for processing virtual tickets. The sequence diagram 200 includes four components: a ticketless airline 202, a travel agency 204, a GDS 206, and a clearinghouse 208. In certain implementations, the ticketless airline 202 can transmit flight schedules—as indicated by arrow 210—that include values that indicate which flights are eligible for virtual ticketing. This can occur on a periodic basis as flight information is modified or as new flights are added or old flights are removed. The flight information can be stored in the GDS for access by a variety of entities, such as travel agencies, travel call centers, web servers that facilitate travel reservations, etc.

In the sequence shown, the travel agency 204 requests and receives flight information that includes a virtual ticket itinerary as indicated by arrow 212. The flight information, which includes virtual ticketing indicators, can be displayed so that it appears similar to reservation formats that include other ticketing indictors, such as e-ticket or paper ticket indicators.

In the implementation shown in FIG. 2, if virtual ticketing is selected for a flight segment, the travel agency 204 can request that the GDS 206 generate a virtual ticket number, as shown by arrow 214. The GDS can generate the virtual ticket number for the flight segment and store the number as well as transmit it to the travel agency 204, as shown by arrow 216.

The travel agency 204 can, in turn, transmit the virtual ticket number to the ticketless airline 202 (as indicated by arrow 218), which then flies the passenger and records the fulfillment of the transaction as indicated by arrow 220. The travel agency 204 can also transmit the virtual ticket number to the clearinghouse 208, as indicated by arrow 222.

In another implementation (not shown in FIG. 2), the ticketless airline 202 can generate the virtual ticket number and transmit it to the travel agency 204, the GDS 206, or the clearinghouse 208.

After the airline has flown the passenger (or otherwise fulfilled the transaction), the ticketless airline can transmit a request to the clearinghouse to settle the payments associated with the virtual ticket number, as indicated by arrow 224. The clearinghouse 208 can use the virtual ticket to collect payment from the travel agency (that previously transmitted the virtual ticket number to the clearinghouse) and transfer the payment to the ticketless airline 202 that previously sent the request for settlement.

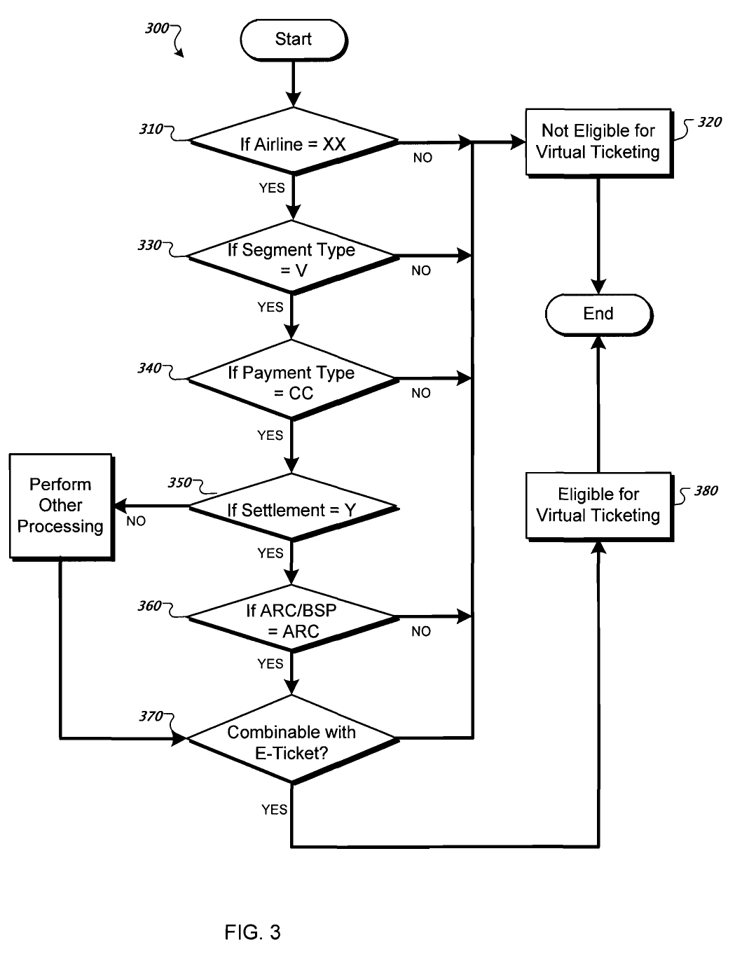

FIG. 3 is a flow chart of an exemplary process 300 for determining whether an itinerary is eligible for virtual ticketing. The process may output a signal indicating an itinerary is eligible or ineligible based on a variety of conditions, some of which are listed in the process 300. The GDS, airline system, or other systems that process the virtual ticket information can identify eligible itineraries by executing process 300.

In step 310, it is determined whether the airline responsible for the flight or flights of the itinerary matches an airline from a list of airlines that permits virtual ticketing. If the given airline does not match one from the list, the process performs step 320, which indicates that the itinerary is not eligible for virtual ticketing. If the given airline matches an airline from the list, step 330 is performed.

In step 330, the segment type for the given itinerary is compared to a list of segment types that can be associated with virtual ticketing. For example, domestic flight segments of NORTHWEST AIRLINES may be eligible, while international flight segments may not be. If the segment type is not approved for virtual ticketing, step 320 is performed and the itinerary is marked as ineligible for virtual ticketing. If the segment type does match a segment type approved for virtual ticketing, step 340 can be performed.

In step 340, the payment type can be checked. If the payment type matches a type approved for virtual ticketing, step 350 can be performed. For example, if the payment type is “cc,” or credit card, the itinerary may be eligible; however, if the payment type is “ck,” or check, the itinerary may not be eligible, and step 320 can be performed as described above.

In step 350, it can be determined if a settlement request to a clearinghouse is necessary for the itinerary. If so, step 360 can be performed. If not, step “other processing” can be performed.

For example, the other processing can include direct financial payments, or settlement, between the travel agency system 112 and the ticketless airline system 102. In another example, the other processing can include transmission of compensation (or an agreement to compensate) to the ticketless airline system 102 from a customer, such as the traveler. In this example, the traveler may have requested the reservation through a web server that has access to a reservation system within the ticketless airline system.

In step 360, the type of clearinghouse associated with the itinerary can be matched with a list of clearinghouses that support virtual ticketing. For example, the list may include the Airlines Reporting Corporation (ARC), but not the Billing and Settlement Plan (BSP). If the clearinghouse associated with the itinerary specifies the ARC, step 370 can be performed, otherwise, step 320 is performed, and the itinerary is marked as not eligible for virtual ticketing.

In step 370, the itinerary is checked to see if the listed flight segment(s) are combinable with a specified ticketing type or types, such as if it is combinable with e-ticket requirements of another airline included in the inter-airline itinerary. If it is combinable, the itinerary can be associated with a specifier indicating eligibility for virtual ticketing, as indicated by step 380, and the process can end. If the itinerary is not combinable, step 320 can be performed, and the process can end.

In another implementations, the step 370 may follow the step 310. For example, after the determination of whether the airline is one that supports virtual ticketing, step 370 can be performed to determine whether virtual ticketing is combinable with the e-ticket requirements of other airlines included in the inter-airline itinerary.

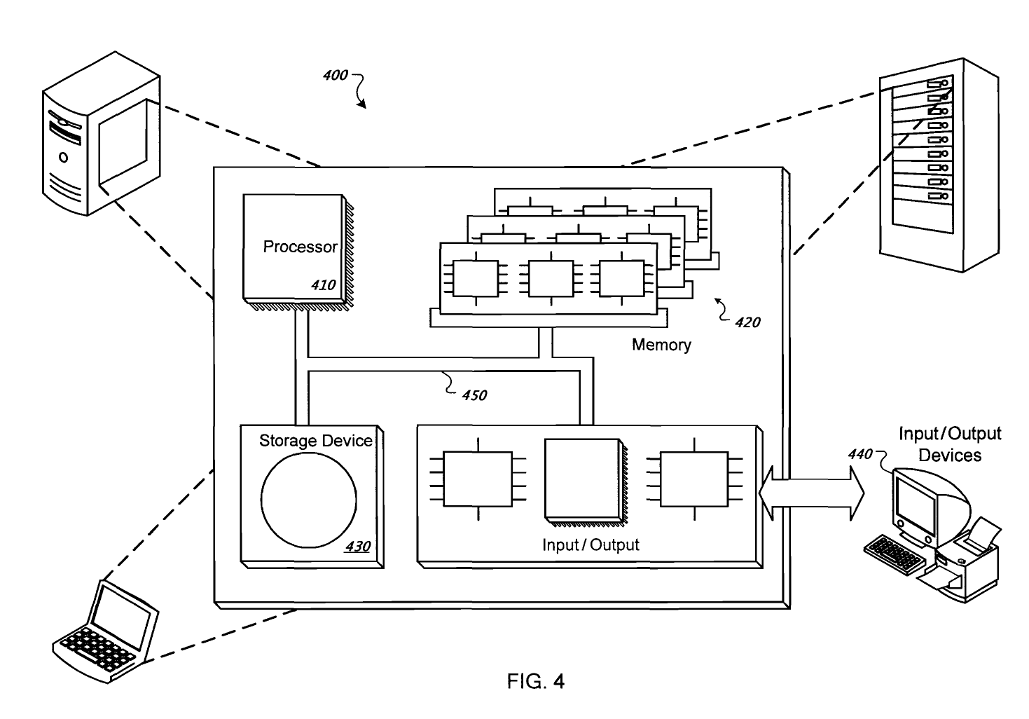

FIG. 4 is a schematic of a general computing system 400.

The system 400 can be used for the operations described in association with any of the computer-implement processes described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a Iloppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and process steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations have been described in detail above, other modifications are possible. For example, although the above implementations are described in the context of an airline system, the systems and processes can be implemented in other contexts as well. In other implementations, the systems and processes can be used in contexts, such as passenger rail systems, tour operation systems, cruise ship systems, and other reservation or seat-based product systems. For example, the system 102 can be a ticketless cruise reservation system instead of a ticketless airline reservation.

In other implementations, the clearinghouse system is absent from the system 100. Instead of using the clearinghouse system 108 as a broker, the ticketless airline system 102 can directly settle financial obligations with other systems, such as the travel agency system 106.

Additionally, the logic flows depicted in the figures do not require the particular order shown, or sequential order, to achieve desirable results. In addition, other steps may be provided, or steps may be eliminated, from the described flows, and other components may be added to, or removed from, the described systems. Also, although the description above describes ticket values in terms of numbers, other values may be used. For example, a virtual ticket value may be an alphanumeric value or include other symbols. Accordingly, other implementations are within the scope of the following claims.

What is claimed is:

1. A computer-implemented process for processing travel transactions without tickets, comprising:
generating an electronic reservation record for a traveler that includes a reservation for travel along a travel segment;
modifying the electronic reservation record to include a virtual ticket value that is unassociated with an electronic or physical ticket;
digitally transmitting the electronic reservation record having the virtual ticket value to a remote computing system that uses the electronic reservation record as exclusive evidence that the reservation has been confirmed for the traveler by a travel provider, wherein the use of the electronic reservation record is exclusive of the presence or absence of any electronic or physical tickets.

2. The process of claim 1, wherein the electronic reservation record is generated by a system selected from a group consisting of an airline reservation system, a cruise ship reservation system, a passenger rail reservation system, a tour reservation system.

3. The process of claim 1, wherein a travel agency system generates the electronic reservation record.

4. The process of claim 2, wherein the travel agency system requests the virtual ticket value associated with the travel segment from a travel provider providing the travel along the travel segment.

5. The process of claim 2, wherein the travel agency requests the virtual ticket value associated with the travel segment from a global distribution system (GDS).

6. The process of claim 1, wherein the remote system is a clearinghouse that uses the electronic reservation record as evidence that the reservation has been confirmed and initiates a settlement process for the travel provider that fulfilled the travel along the travel segment.

7. The process of claim 1, wherein the travel provider transmits to the remote system a settlement request that includes the electronic reservation record as the exclusive evidence that the travel provider has confirmed the reserved travel for the traveler.

8. The process of claim 1, wherein the electronic reservation record includes a second travel segment that is associated with an electronic ticket value that identifies a particular electronic ticket.

9. The process of claim 8, further comprising transmitting information associated with the particular electronic ticket along with the electronic reservation record as evidence that the second travel segment has been confirmed.

10. The process of claim 1, wherein the remote system uses the virtual ticket value in a substantially similar manner as the remote system uses electronic ticket values and physical ticket values in accounting and transaction records.

11. A computer-implemented process of digitally processing travel changes between travel providers, the process comprising:
digitally modifying an electronic passenger name record (PNR) with travel information that has changed, the electronic PNR comprising a requested travel itinerary and a virtual ticket value associated with a first segment of travel; and
digitally transmitting the electronic PNR having the virtual ticket value from a first travel provider system to a second travel provider for use in setting the travel itinerary and for providing exclusive evidence of a commitment to compensate the second travel provider for providing the first segment of travel to a passenger associated with the electronic PNR.

12. The process of claim 11, wherein modifying the electronic PNR with changed travel information comprises cancelling an earlier reserved travel segment serviced by the first travel provider.

13. The process of claim 12, wherein modifying the electronic PNR with changed travel information further comprises adding the first travel segment so that the first travel segment is serviced by the second travel provider.

14. The process of claim 11, wherein the commitment to compensate is between the first and second travel providers.

15. The process of claim 11, wherein the commitment to compensate is between the passenger and the second travel provider.

16. The process of claim 11, wherein the commitment to compensate is between a travel agency and the second travel provider.

17. The process of claim 11, wherein the commitment to compensate is between a clearinghouse and the second travel provider.

18. The process of claim 11, wherein the first segment of travel is not associated with an electronic or physical ticket.

19. A system for processing ticketless travel transactions comprising:
a travel agency system to generate an electronic travel reservation record having a travel segment associated with a virtual ticket value but unassociated with an electronic or physical ticket;
a travel provider system to receive the electronic travel reservation record having the virtual ticket value and to provide travel for a passenger along the travel segment without receiving any electronic or physical tickets associated with the travel segment; and
a clearinghouse system to receive the virtual ticket value from the travel provider as exclusive evidence that the travel provider has committed to provide the travel along the travel segment.

20. The system of claim 19, further comprising a global distribution system (GDS) to receive digital travel schedules from the travel provider system that indicated travel segments that are associated with virtual ticket values.

21. The system of claim 20, wherein the travel agency system requests the travel segments associated with virtual ticket values from the GDS.
